(19) United States
(12) Patent Application Publication
(10) Pub. No.: US 2004/0141513 A1
(43) Pub. Date: Jul. 22, 2004

(54) Address translation device

(76) Inventors: Ryuichi Takechi, Kawasaki (JP); Tsuguo Kato, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/754,937

(22) Filed: Jan. 9, 2004

(30) Foreign Application Priority Data
Jan. 10, 2003 (JP) 2003-004503

(51) Int. Cl. H04L 12/56

(52) U.S. Cl. 370/401; 370/471

(57) ABSTRACT

An address translation device comprising extraction unit for extracting, from data received via a first network, a fixed identifier indicating a transmission source of the data, storage unit for storing the fixed identifier and an address, in a second network, of the transmission source indicated by this fixed identifier by relating the fixed identifier and the address each other, reading unit for reading the address, in the second network, stored on the storage unit related to the fixed identifier extracted by the extraction unit, and replacing unit for replacing the address in the second network read by the reading unit with the source address of the data.

### BACKGROUND OF THE INVENTION

The present invention relates to a packet translation device for translating a packet and sending it.

There has hitherto been an IPv4-IPv6 translation device for translating an IPv4 (Internet Protocol Version 4) packet into an IPv6 (Internet Protocol Version 6) packet. There is no compatibility between the IPv4 packet and the IPv6 packet. Hence, on the occasion that an IPv4 terminal and an IPv6 terminal perform communications, the device (the IPv4-IPv6 translation device) for mutually translating the IPv4 packet and the IPv6 packet is required be somewhere on a packet forwarding route between the two terminals. Address translation methods in this type of IPv4-IPv6 translation device are disclosed by way of RFC2766, RFC2765, RFC3142(which are Non-Patent documents 1, 2, 3, respectively) by, for example, IETF (Internet Engineering Task Force). Further, Patent document 1 is given as an example of this type of IPv4-IPv6 translation device. RFC2766 will hereinafter be explained by way of an example of the conventional address translation method.

FIG. 18 is a view illustrating a communication system between the IPv6 terminal and the IPv4 terminal by use of an RFC2766 (NAT-PT) system. The system shown in FIG. 18 includes a terminal device P2 connected to and corresponding to an IPv6 network P1, a server P4 connected to and corresponding to an IPv4 network P3, and an IPv4-IPv6 translation device P5 interposed between the IPv6 network P1 and the IPv4 network P3 and connected to both of the networks.

In the IPv6 network P1, an IP address containing a network prefix (ex:“FEDC:BA00::/32”) allocated to an IPv6 network sided interface of the IPv4-IPv6 translation device P5, undergoes routing (is routed) by the IPv4-IPv6 translation device P5. Similarly, in the IPv4 network P3, an IP address containing a network prefix (ex:“120.130.26.xx”) allocated to an IPv4 network sided interface of the IPv4-IPv6 translation device P5, undergoes routing by the IPv4-IPv6 translation device P5.

Operations of the system including the IPv4-IPv6 translation device P5 will hereinafter be described. To start with, an operation on the occasion that the terminal device P2 transmits a packet to the server P4, will be explained. The terminal device P2, on the occasion of transmitting the packet to the server P4, generates a destination address (DA) (ex:“FEDC:BA00::132.146.243.30”) by use of the network prefix (ex:“FEDC:BA00::/32”) of the IPv6 network P1 and the IPv4 address (ex:“132.146.243.30”) of the server P4. Further, the terminal device P2 uses its own IPv6 address as a source address (SA) (ex:“FEDC:BA98::7654:3210”). The terminal device P2 assembles an IPv6 packet by use of these destination address and source address and transmits this packet.

The IPv4-IPv6 translation device P5, upon receiving the IPv6 packet from the terminal device P2, reads an IPv4 address (ex:“120.130.26.1”) out of an IPv4 address pool provided by itself. Then, the IPv4-IPv6 translation device P5 temporarily assigns the readout IPv4 address to the terminal device P2. The IPv4-IPv6 translation device P5 records, in a translation table P6, this IPv4 address and the source address (i.e., the IPv6 address of the terminal device P2) of the received packet in a way that makes them mapping to each other.

Next, the IPv4-IPv6 translation device P5 executes an IPv6/IPv4 header translation. Namely, the IPv4-IPv6 translation device P5 rewrites a header (an IPv6 header) of the received IPv6 packet into a header (an IPv4 header) of the IPv4 packet. At this time, the IPv4-IPv6 translation device P5, with respect to the destination address, generates the IPv4 header (ex:“132.146.243.30”) by deleting the network prefix. Further, the IPv4-IPv6 translation device P5, with respect to the source address, generates the IPv4 header (ex:“120.130.26.1”) by use of the IPv4 address recorded in the translation table P6. The IPv4-IPv6 translation device P5 forwards, to the IPv4 network P3, the packet in which the IPv6/IPv4 header translation has been effected.

Next, an operation on the occasion the server P4 sends the packet back to the terminal device P2 will be explained. The server P4, on the occasion of transmitting the packet to the terminal device P2, sets, as a destination address, the IPv4 address temporarily assigned to the terminal device P2 by the IPv4-IPv6 translation device P5. Furthermore, the server P4 uses its own IPv4 address as a source address.

The IPv4-IPv6 translation device P5, upon receiving the IPv4 packet from the server P4, executes the IPv4/IPv6 header translation. Namely, the IPv4-IPv6 translation device P5 rewrites the IPv4 header of the received packet into the IPv6 header. At this time, the IPv4-IPv6 translation device P5, with respect to the destination address, generates the IPv6 header by use of the IPv6 address recorded mapping (corresponding) to the destination address of the IPv4 header in the translation table P6. Further, the IPv4-IPv6 translation device P5, with respect to the source address, generates the IPv6 header by adding the network prefix of the IPv6 network P1 to the source address of the IPv4 header. The IPv4-IPv6 translation device P5 forwards, to the IPv6 network P1, the packet in which the IPv4/IPv6 header translation has been effected.

On the other hand, a mobile IP has been considered as a technology for performing seamless communications on a network configured by connecting a variety of access networks to the Internet. The mobile IPs are disclosed by way of RFC2002 (Non-Patent document 4) according to IPv4 and by way of Internet draft “draft-ietf-mobileip-ipv6-19.txt” (Non-Patent document 5) according to IPv6 by the IETF.

FIG. 19 is a view showing a conventional function of the mobile IPv6. In the system shown in FIG. 19, a MN (Mobile Node) P8, a HA (Home Agent) P9 and a CN (correspondent Node) P10 are connected to an IPv6 network P7. According to the mobile IPv6, a home address (HoA) (ex:“1234::5678”) is assigned beforehand to the MN P8 moving across the IPv6 network P7. The MN P8 obtains a care-of address (CoA) (ex:“FEDC::3210”) used in a destination to which it will move, and sends a registration message (Binding Update: BU) to the HA P9 as a mobile management agent. The registration message contains the home address and the care-of address of the MN P8. Then, the HA P9 caches a binding cache P11 for a fixed period of time with the home address and the care-of address contained in the received registration in a way that makes them mapping to each other.

The CN P10, in the case of transmitting the packet to the MN P8, designates the home address of the MN P8 as a destination address. When this type of packet is forwarded to the IPv6 network P7, the HA P9 intercepts (receives) this packet. The HA P9 reads the care-of address mapping to the destination address (i.e., the home address of the MN P8) of the intercepted packet from the binding cache P11 provided by itself. The HA P9 encapsulates the received packet, wherein the readout care-of address is set as a destination address and the self-device address is set as a source address. Then, the HA P9 forwards the encapsulated packet to the IPv6 network.

The MN P8 receives the encapsulated packet. Then, the MN P8 decapsulates the received packet, thereby acquiring the packet forwarded from the CN P10. At this time, the MN P8 judges that the destination address and the source address are the home address of the MN P8 and the address of the CN P10, respectively. These two values remain fixed irrespective of where the MN P8 moves. Accordingly, even when the care-of address of the MN P8 changes due to a movement of the MN P8, the application of the MN P8 does not judge that a session is interrupted (the source address or the destination address in the communications is translated), whereby the seamless communications become possible.

The MN P8, in the case of transmitting the packet to the CN P10, uses the address of the CN P10 as the destination address, and uses the care-of address assigned to itself as the source address. At this time, the MN P8 stores the home address of itself in a home address option field as an address option of the IPv6 header of this packet. The CN P10, in case the received packet contains the home address option, judges from the address indicated by this home address option that the packet has arrived.

At this time, the application of the CN P10 judges that the destination address and the source address are the address of the CN P10 and the home address of the MN P8, respectively. These two values remain fixed irrespective of where the MN P8 moves. Accordingly, even when the care-of address of the MN P8 changes due to a movement of the MN P8, the application of the CN P10 does not judge that a session is interrupted (the source address or the destination address in the communications is translated), whereby the seamless communications become possible.

[Patent document 1]

Japanese Patent Application Laid-Open Publication No.2001-274845

[Non-Patent document 1]

“Network Address Translation-Protocol Translation—Protocol Translation (NAT-PT)”, InternetURL:http://www.ietf.org/rfc/rfc2766.txt?number=2766

[Non-Patent document 2]

“Stateless IP/ICMP Translation Algorithm (SIIT)”, InternetURL:http://www.ietf.org/rfc/rfc2765.txt?numbe r=2765

[Non-Patent document 3]

“An IPv6-to-IPv4 Transport Relay Translator”, InternetURL:http://www.ietf.org/rfc/rfc3142.txt?numbe r=3142

[Non-Patent document 4]

“IP Mobility Support”, InternetURL:http://www.ietf.org.rfc/rfc2002.txt?numbe r=2002

[Non-Patent document 5]

“Mobility support in IPv6<draft-ietf-mobileip-ipv6-19.txt>”, InternetURL:http://ietf.org/internet-draft-ietf-mobileip-ipv6-19.txt

### SUMMARY OF THE INVENTION

In case a MN P8 using mobile IPv6 performs communications with, for example, an IPv4 host (.e.g., a server P4 in FIG. 18), however, the following problem arises. In this case, a packet communicated between the MN P8 and the IPv4 host is through an IPv4-IPv6 translation device (for instance, an IPv4-Ipv6 translation device P5 in FIG. 18). Therefore, on the occasion that the MN P8 transmits the packet to the IPv4 host, the IPv4-IPv6 translation device assigns a temporary IPv4 address to the MN P8, stores its mapping relationship in a translation table (for example, a translation table P6 in FIG. 18). At this time, the IPv4-IPv6 translation device uses a source address indicated in a header of the received IPv6 packet, i.e., a care-of address of the MN P8 as an IPv6 address to be recorded in the translation table.

In a case where the care-of address changes as the MN P8 moves, there changes the source address in the header of the IPv6 packet to be transmitted to the IPv4 host by the MN P8. Therefore, the IPv4-IPv6 translation device judges that a session based on the present care-of address is a session different from a session based on a care-of address before being changed. Accordingly, the IPv4-IPv6 translation device assigns afresh a temporary IPv4 address with respect to the care-of address after being changed and records it in the translation table. Hence, the IPv4 host judges that the session with the MN P8 is interrupted because of a change of the IPv4 address (the source address of the packet forwarded by the IPv4-IPv6 translation device) pertaining to the communication party (MN P8).

Such being the case, the invention aims at solving such a problem and providing an address translation device enabling, in case one terminal device (for instance, an IPv6 terminal) has a mobility function of mobile IPv6, etc. in an information communication network such as an IP network, etc., even on such an occasion that an address (e.g., a care-of address) of one terminal device changes, a continuation of communications with the other terminal device (viz., enabling seamless communications).

To solve the problems, the invention takes the following architectures. A first mode of the invention is an address translation device comprising, extraction unit extracting, from data received via a first network, a fixed identifier indicating a transmission source of the data, storage unit storing the fixed identifier and an address, in a second network, of the transmission source indicated by this fixed identifier by relating the fixed identifier and an address each other (in a way that makes them mapping to each other), reading unit reading the address, in the second network, stored on the storage unit in a way that makes it mapping to the fixed identifier extracted by the extraction unit, and

replacing unit replacing the in-the-second-network address read by the reading unit with the source address of the data.

According to the first mode of the invention, the extraction unit extracts, from the date received via the first network, the fixed identifier indicating the transmission source of the data. This type of first network is exemplified by an IPv6 network, etc. Further, this type of fixed identifier is, for example, an identifier that remains unchanged even when the terminal device moves, etc. as the home address in mobile IPv6 does, and is exemplified such as a telephone number, URL (Uniform Resource Locator), etc. assigned to the terminal device.

The storage unit is stored with the fixed identifier and the in-the-second-network address of the transmission source indicated by this fixed identifier in a way that makes them mapping to each other. This type of second network is exemplified by an IPv4 network, etc. In this case, the address stored becomes an IPv4 address.

The reading unit reads the address stored on the storage unit in a way that makes it mapping to the fixed identifier extracted by the extraction unit. Then, the replacing unit replaces the address read by the reading unit with the source address of the data as the processing object.

Therefore, even in case the address assigned to the transmission source of a certain piece of data is changed, with respect to the data sent from the same transmission source, the transmission source is distinguished by the fixed identifier, and the same source address is added to the data. Accordingly, the transmission destination of the data is capable of receiving the data to which the source address having the same value irrespective of the change in the address assigned to the transmission source of the data is added. Hence, a judgment of “interruption” by which the change of the transmission destination is accompanied, is avoided, so that seamless communications between the transmission destination and the transmission source of the data can be performed.

Moreover, the first mode of the invention may take an architecture further comprising identifier extraction unit extracting a variable address of a terminal device connected to the first network and the fixed identifier from the data received via the first network, identifier storage unit storing the variable address and the fixed identifier extracted by the identifier extraction unit in a way that makes them mapping to each other, variable address acquisition unit acquiring, from the storage unit and from the identifier storage unit, the variable address mapping to a destination address of the data addressed to the terminal device, which contains, as a destination address, the in-the-second-network address received via the second network, and rewrite unit rewriting the destination address of the received data into the variable address acquired by the variable address acquisition unit.

A second mode of the invention is a packet translation device, interposed between an IPv6 (Internet Protocol version 6) network and an IPv4 (Internet Protocol version 4) network, for mutually translating an IPv4 packet and an IPv6 packet, comprising extraction unit extracting, from the IPv6 packet, a fixed identifier indicating a transmission source of this IPv6 packet, storage unit storing the fixed identifier and an IPv4 address assigned to this transmission source in a way that makes them mapping to each other, reading unit reading the IPv4 address stored on the storage unit in a way that makes it mapping to the fixed identifier extracted by the extraction unit, and packet translating unit translating the IPv6 packet into the IPv4 packet with the IPv4 address read by the reading unit being set as a source address.

Further, the second mode of the invention may take an architecture of further comprising identifier receiving unit receiving data containing a care-of address of an IPv6 terminal device and the fixed identifier indicating this IPv6 terminal device, identifier storage unit storing the care-of address and the fixed identifier that have been received by the identifier receiving unit in a way that makes them mapping to each other, and care-of address acquisition unit acquiring the care-of address mapping to a destination address of the received IPv4 packet from the storage unit and from the identifier storage unit, wherein the packet translating unit translates the IPv4 packet into an IPv6 packet with the care-of address acquired by the care-of address acquisition unit being set as a destination address.

Moreover, the storage unit in the second mode of the invention may be structured to further store a port number mapping thereto, and the reading unit may be constructed to read the IPv4 address stored on the storage unit in a way that makes it mapping to the fixed identifier extracted by the extraction unit and to a source port number of the IPv6 packet received.

### DESCRIPTION OF THE DRAWINGS

FIG. 1 is a view showing an outline of an IPv4-IPv6 translation system using a first embodiment of the invention;

FIG. 2 is a block diagram of an IPv4-IPv6 translation device as the first embodiment of the invention;

FIG. 3 is a diagram showing an example of an address translation table in the first embodiment of the invention;

FIG. 4 is a diagram showing an operation sequence of an IPv4-IPv6 translation system using the first embodiment of the invention;

FIG. 5 is a diagram showing the operation sequence of the IPv4-IPv6 translation system using the first embodiment of the invention;

FIG. 6 is a diagram showing an outline of the IPv4-IPv6 translation system using a second embodiment of the invention;

FIG. 7 is a block diagram of the IPv4-IPv6 translation device as the second embodiment of the invention;

FIG. 8 is a diagram showing an example of the address translation table in the second embodiment of the invention;

FIG. 9 is a diagram showing a data structure of a packet by an encapsulation method;

FIG. 10 is a diagram showing a data structure of a packet by a routing header method;

FIG. 11 is a diagram showing an operation sequence of the IPv4-IPv6 translation system using the second embodiment of the invention;

FIG. 12 is a diagram showing the operation sequence of the IPv4-IPv6 translation system using the first embodiment of the invention;

FIG. 13 is a diagram showing an outline of the IPv4-IPv6 translation system using a third embodiment of the invention;

FIG. 14 is a block diagram of the IPv4-IPv6 translation device as the third embodiment of the invention;

FIG. 15 is a diagram showing an operation sequence of an IPv4-IPv6 translation system using the third embodiment of the invention;

FIG. 16 is a diagram showing the operation sequence of the IPv4-IPv6 translation system using the third embodiment of the invention;

FIG. 17 is a diagram showing a modified example of the address translation table of the invention;

FIG. 18 is a diagram showing an outline of an IPv4-IPv6 translation system using a conventional IPv4-IPv6 translation device; and

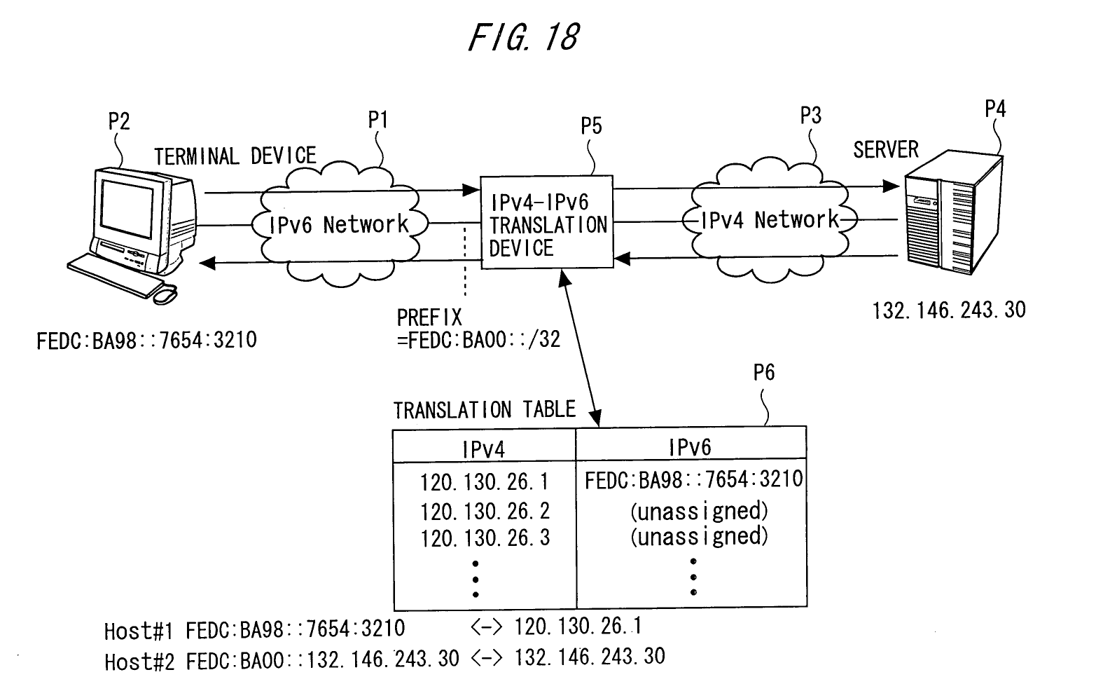

FIG. 19 is a diagram showing an outline of a system using conventional mobile IPv6.

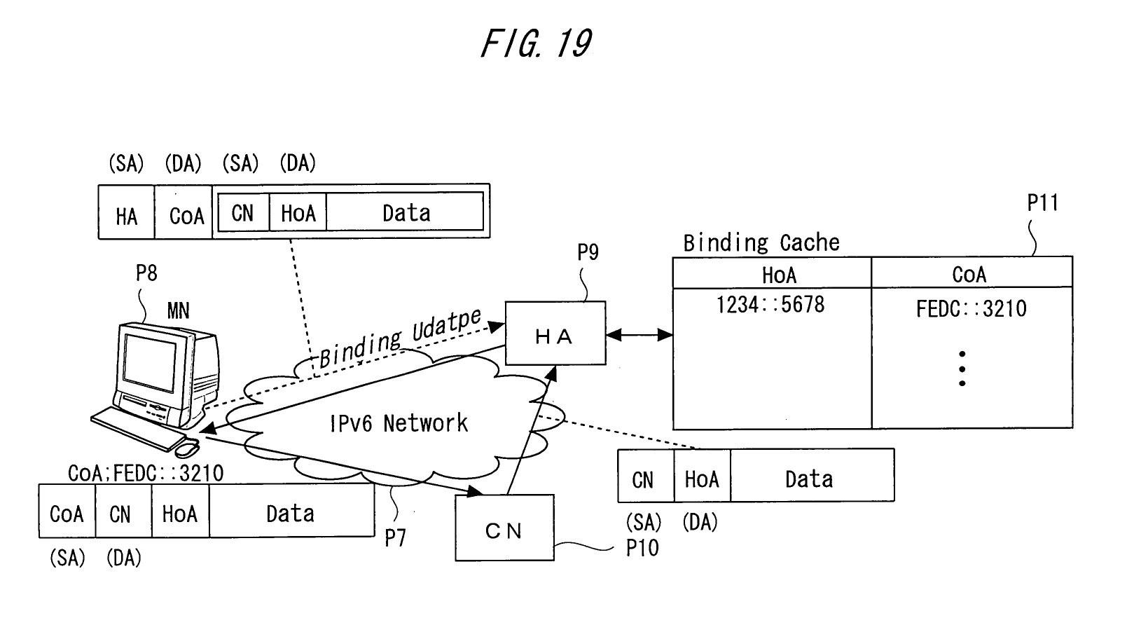

### DETAILED DESCRIPTION OF THE INVENTION

Next, an address translation device in an embodiment of the invention will be described by use of the drawings. The following description assumes particularly IP communications performed between a communication device connected to an IPv4 network and a communication device connected to an IPv6 network, and will be made using an IPv4-IPv6 translation device by way of a concrete example of the address translation device. Note that the description of the embodiment is an exemplification, and architecture of the invention is not limited to the following description.

[First Embodiment]

<System Architecture>

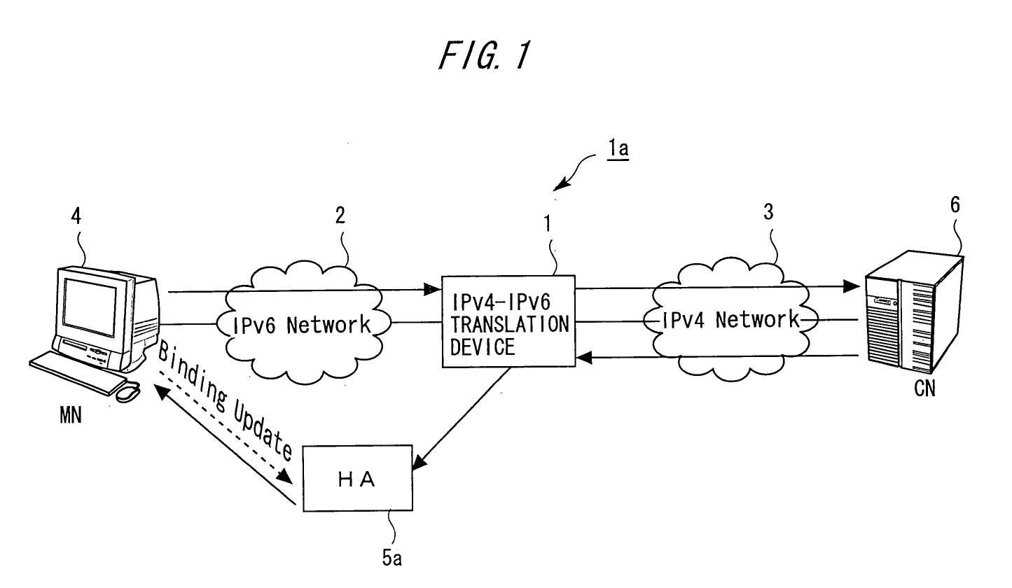

FIG. 1 is a view showing an outline of an IPv4-IPv6 translation system 1a that uses a first embodiment of the address translation device according to the present invention, i.e., uses an IPv4-IPv6 translation device 7a. The IPv4-IPv6 translation system 1a illustrated in FIG. 1 will hereinafter be explained.

A network of the IPv4-IPv6 translation system 1a is configured by an IPv6 network 2 and an IPv4 network 3. In the IPv4-IPv6 translation system 1a, a M 4 and a HA 5a are connected to the IPv6 network 2. Further, in the IPv4-IPv6 translation system 1a, the IPv4-IPv6 translation device 7a is connected to between the IPv6 network 2 and the IPv4 network 3. Each of constructions will hereinafter be explained.

The MN 4 is constructed by use of an information processing device such as a personal computer, PDA (Personal Digital Assistants), etc. The MN 4 functions as a mobile node of the mobile IPv6. It is therefore desirable that the MH 4 be an information processing device having a portability. In the first embodiment, the HA 5a is registered as a home agent in the MN 4. Accordingly, in the first embodiment, the MN 4 transmits a registration message to the HA 5a.

The HA 5a is constructed by use of an information processing device such as a personal computer, a workstation, etc., or by use of a communication device such as a router, etc. The HA 5a functions as a home agent of the mobile IPv6.

A CN 6 is constructed by use of an information processing device such as a personal computer, a workstation, etc. The CN 6 transmits and receives an IP packet to and from the MN 4.

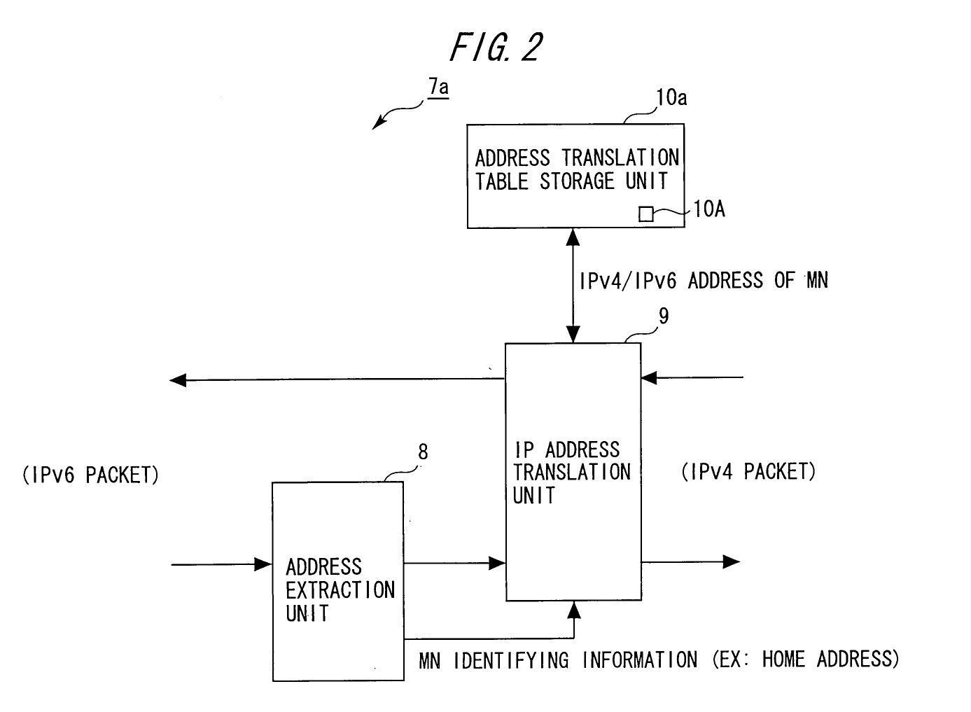

The IPv4-IPv6 translation device 7a is constructed by use of an information processing device such as a personal computer, a workstation, etc., or by use of hardware dedicated to an address translation. FIG. 2 is a block diagram showing an architecture of the IPv4-IPv6 translation device 7a. The IPv4-IPv6 translation device 7a will be described by using FIG. 2.

The IPv4-IPv6 translation device 7a includes, hardwarewise, a CPU, a main memory (RAM), an auxiliary storage device (a hard disk), etc., which are connected via a bus. A variety of programs (OS, application, etc.) stored on the auxiliary storage device are loaded into the main memory and executed by the CPU, whereby the IPv4-IPv6 translation device 7a functions as a device including an address extraction unit 8, an IP address translation unit 9 and an address translation table storage unit 10a.

The IPv4-IPv6 translation device 7a receives an IPv6 packet or an IPv4 packet. The IPv4-IPv6 translation device 7a, upon receiving the IPv6 packet, transfers the received IPv6 packet to the address extraction unit 8. Further, the IPv4-IPv6 translation device 7a, upon receiving the IPv4 packet, transfers the received IPv4 packet to the IP address translation unit 9.

The address extraction unit 8 is constructed by use of a CPU, a RAM, etc. The address extraction unit 8 extracts a home address of the MN 4 as a piece of MN identifying information contained in the IPv6 packet received from the MN 4. At this time, the home address to be extracted is an IPv6 address. Then, the address extraction unit 8 notifies the IP address translation unit 9 of the extracted home address.

The IP address translation unit 9 is constructed by use of a CPU, a RAM, etc. The IP address translation unit 9, when notified of the home address from the address extraction unit 8, checks whether there is an entry containing this home address in the address translation table 10A. In case the address translation table 10A has none of such an entry, the IP address translation unit 9 reads the IPv4 address out of an unillustrated IPv4 address pool provided by itself. The IP address translation unit 9 assigns the readout IPv4 address as a temporary IPv4 address to the MN 4. Then, the IP address translation unit 9 records, in the address translation table 10A, an entry containing the readout IPv4 address and the notified home address. While on the other hand, in case the address translation table 10A has the entry, the IP address translation unit 9 reads the IPv4 address contained in this entry out of the address translation table 10A.

The IP address translation unit 9 executes an IPv6/IPv4 header translation with respect to the received IPv6 packet. The IP address translation unit 9 generates a destination address of the IPv4 header by deleting a network prefix from a destination address of the IPv6 header. Further, the IP address translation unit 9 generates a source address of the IPv4 header by use of the IPv4 address read from the address translation table 10A or from the IPv4 address pool.

The IP address translation unit 9 executes an IPv4/IPv6 header translation with respect to the received IPv4 packet. The IP address translation unit 9 generates a destination address of the IPv6 header by use of an IPv6 address (i.e., a home address of the MN 4) recorded in the address translation table 10A in a way that makes it mapping to the destination address of the IPv4 header. Moreover, the IP address translation unit 9 generates a source address of the IPv6 header by combining the source address of the IPv4 header with a network prefix of the IPv6 network 2.

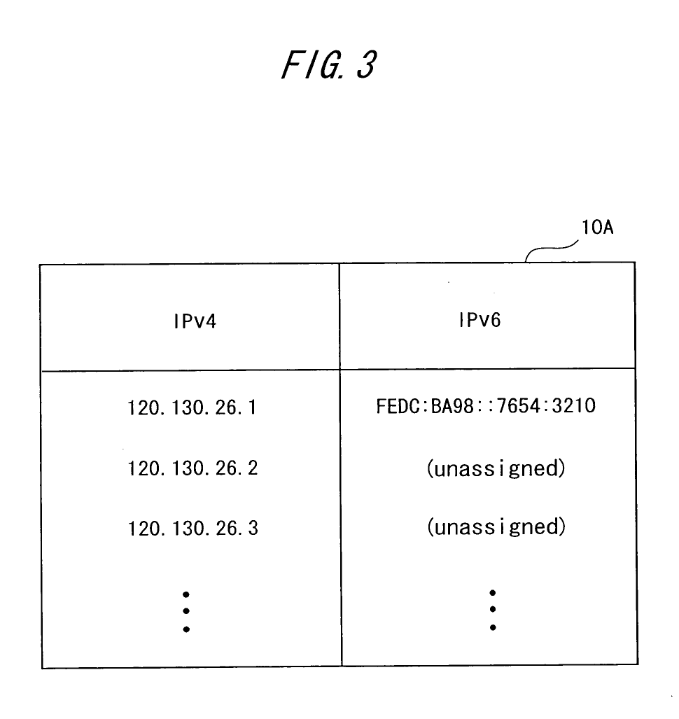

The address translation table storage unit 10a is constructed by use of either a nonvolatile memory such as a flash memory, etc. or a volatile memory such as a SDRAM, etc. The address translation table storage unit 10a is stored with the address translation table 10A. FIG. 3 is a diagram showing an example of a structure of the address translation table 10A. The address translation table 10A will be explained by use of FIG. 3.

The address translation table 10A is recorded with the entry of the IPv4 address and the IPv6 address in a way that makes them mapping to each other. The IPv4 address contained in this entry is the IPv4 address read out of the IPv4 address pool by the IP address translation unit 9. Further, the IPv6 address contained in this entry is the home address of the MN 4 that is read out by the address extraction unit 8.

<Operation Sequence>

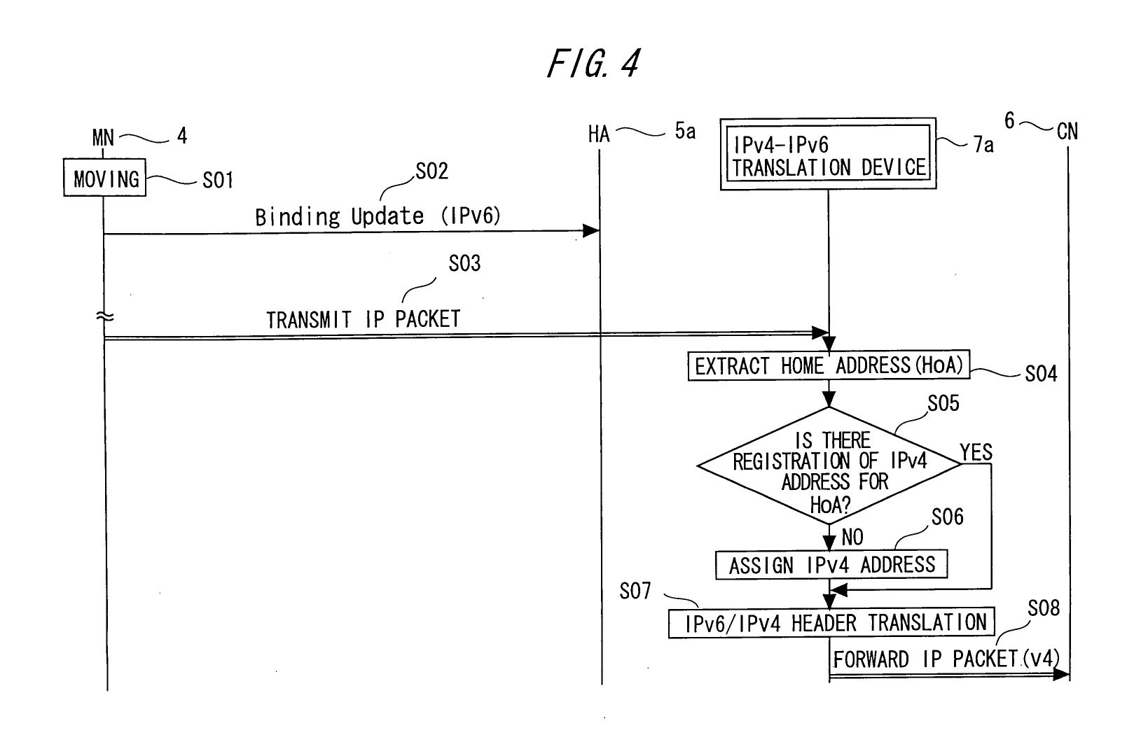

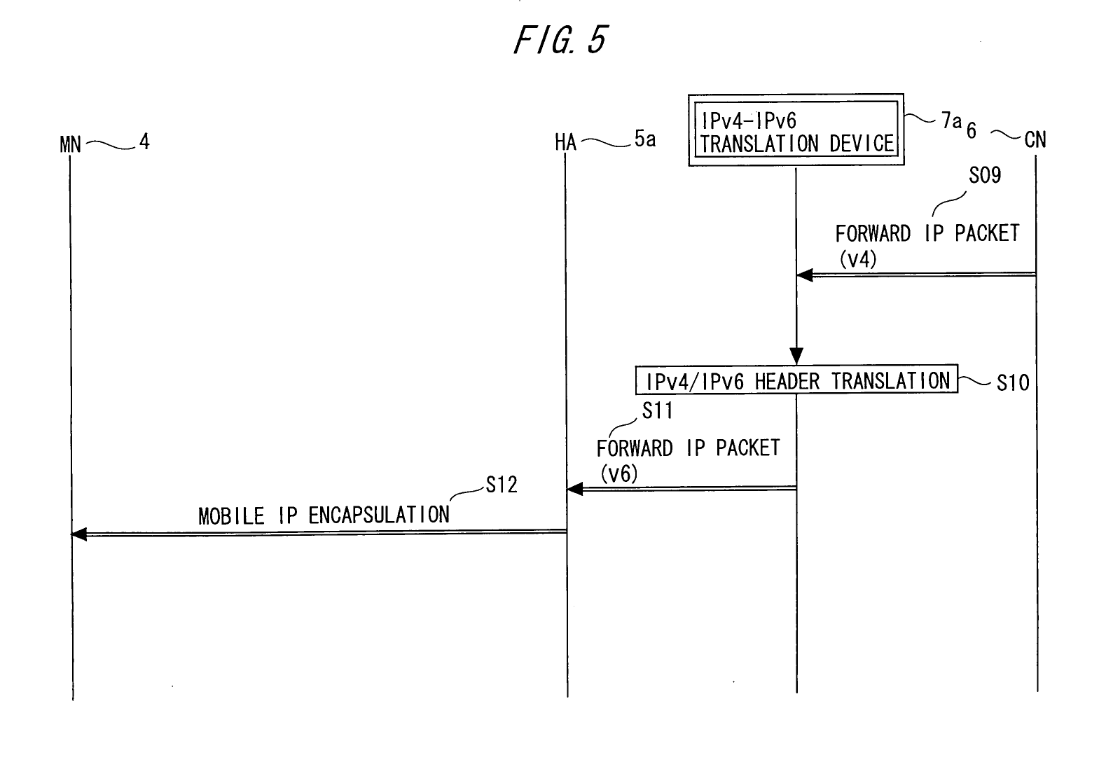

FIGS. 4, 5 are diagrams showing an operation sequence of the IPv4-IPv6 translation system 1a using the first embodiment of the invention. The operation sequence of the IPv4-IPv6 translation system 1a will hereinafter be described by use of FIGS. 4, 5 in a way that divides it into a location registering process, an IPv6/IPv4 forwarding process and an IPv4/IPv6 forwarding process. Note that, in the following description, unless particularly stated, a destination address and a source address of the packet header will be described in the form of (a destination address, a source address). Further, it is assumed that “FEDC:BA98::7654:3210” and “1234:5678::7654:3210” be assigned as a home address and a care-of address to the MN 4. It is also assumed that the CN 6 be assigned “132.146.243.30” as an IPv4 address. It is further assumed that “FEDC:BA00::/32” and “120.130.26.xx” be assigned as network prefixes respectively to an IPv6 network sided interface and an IPv4 network sided interface of the IPv4-IPv6 translation device 7a.

<<Location Registering Process>>

To begin with, the location registering process will be explained by use of FIG. 4. The MN 4 moves within the IPv6 network (viz., it moves as a subordinates to a certain access router (Access Rooter)) and acquires a new care-of address (S01), and then transmits a registration message to the HA 5a (S02). The HA 5a updates contents of the binding cache provided by itself by use of the registration message received. The process described above is the location registering process.

<<IPv6/IPv4 Forwarding Process>>

Next, the IPv6/IPv4 forwarding process will be explained by use of FIG. 4. In the IPv6/IPv4 forwarding process, the IPv6 packet sent from the MN 4 is translated into an IPv4 packet and forwarded to the CN 6.

The MN 4 transmits the IPv6 packet to the CN 6 (S03). At this time, a header of the packet transmitted by the MN 4 becomes (FEDC:BA00::132.146.243.30.1234:5678::7654:3210). Further, the MN 4 adds the self home address (FEDC:BA98::7654:3210) as a home address option to the packet. This packet transmitted from the MN 4 is received by the IPv4-IPv6 translation device 7a.

When the IPv4-IPv6 translation device 7a receives the packet from the MN 4, the address extraction unit 8 extracts the home address of the MN 4 from a home address option field of this packet (S04). The address extraction unit 8 notifies the IP address translation unit 9 of the extracted home address.

The IP address translation unit 9 refers to the address translation table 10A and thus checks whether or not there is an entry containing the home address which the address extraction unit 8 has notified of (S05). In case there is not the entry (S05-NO), IP address translation unit 9 reads the IPv4 address out of the self IPv4 address pool, and records an entry containing the readout IPv4 address and the notified home address in the address translation table 10A (S06). In case there is the entry (S05-YES), or after finishing recording a new entry, IP address translation unit 9 executes the IPv6/IPv4 header translation (S07). In this case, the entry exists in the address translation table 10A (see FIG. 3), and hence, owing to the execution of the IPv6/IPv4 header translation, the packet header becomes (132.146.243.30,120.130.26.1). With this process, the IPv6 packet received from the MN 4 is translated into an IPv4 packet that should be received by the CN 6. Then, the IPv4-IPv6 translation device 7a forwards the IPv4 packet with its header translated (S08).

<<IPv4/IPv6 Forwarding Process>>

Next, the IPv4/IPv6 forwarding process will be explained by use of FIG. 5. In the IPv4/IPv6 forwarding process, the IPv4 packet sent form the CN 6 is translated into an IPv6 packet and forwarded to the MN 4.

The CN 6 transmits the IPv4 packet to the MN 4 (S09). At this time, a destination address in the header of the packet transmitted by the CN 6 is the IPv4 address temporarily assigned to the MN 4 by the IPv4-IPv6 translation device 7a. Further, a source address in the header of this packet is the self IPv4 address. Namely, the header of the packet transmitted by the CN 4 becomes (120.130.26.1,132.146.243.30). This packet transmitted from the CN 6 is received by the IPv4-IPv6 translation device 7a.

When the IPv4-IPv6 translation device 7a receives this packet from the CN 6, the IP address translation unit 9 executes an IPv4/IPv6 header translation (S10). In this case, owing to the execution of the IPv4/IPv6 header translation, the packet header becomes (FEDC:BA98::7654:3210,FEDC:BA00::132.146.243.30). Then, the IPv4-IPv6 translation device 7a forwards the IPv6 packet with its header translated (S11).

The HA 5a intercepts the IPv6 packet addressed to the MN 4 which has been forwarded from the IPv4 -IPv6 translation device 7a. The HA 5a encapsulates the intercepted IPv6 packet by use of the care-of address assigned to the MN 4, and forwards it to the IPv6 network 2 (S12). Then, this packet arrives at the MN 4. Thus, in the IPv4/IPv6 forwarding process, the packet is forwarded in this sequence of the CN 6, the IPv4-IPv6 translation device 7a, the HA 5a and the MN 4.

<Operation*Effect>

According to the first embodiment of the invention, the address translation table storage unit 10a is stored with the home address of the MN 4 and the IPv4 address temporarily assigned to the MN 4 in a way that makes them mapping to each other. Then, the IP address translation unit 9 rewrites the source address of the IPv6 packet transmitted to the CN 6 from the MN 4 into the IPv4 address stored mapping not to the care-of address contained in this IPv6 packet but to the home address (the home address extracted by the home address extraction unit 8) contained in this IPv6 packet.

Therefore, irrespective of the translation of the care-of address of the MN 4, the fixed IPv4 address is indicated as the source address in the IPv4 packet addressed to the CN 6. Accordingly, there are actualized the seamless communications between the MN 4 as the mobile node (the terminal device having a mobility function) connected to the IPv6 network 2 and the CN 6 connected to the IPv4 network 3.

<Modified Examples>

The MN identifying information of the MN 4 may be whatever information, even if it is not the home address, on condition that it is information contained in the packet of the communication between the MN 4 and the CN 6 as well as being information of which a value does not change even when a location of the MN 4 changes. Other examples of this type of MN identifying information are a telephone number, a URL, etc. which are assigned to the MN 4. The home address is, however, already defined as the address option of the IPv6 packet, and hence the home address is applied as the MN identifying information, thereby enabling an easy and efficient implementation of the IPv4-IPv6 translation system 1a.

[Second Embodiment]

<System Architecture>

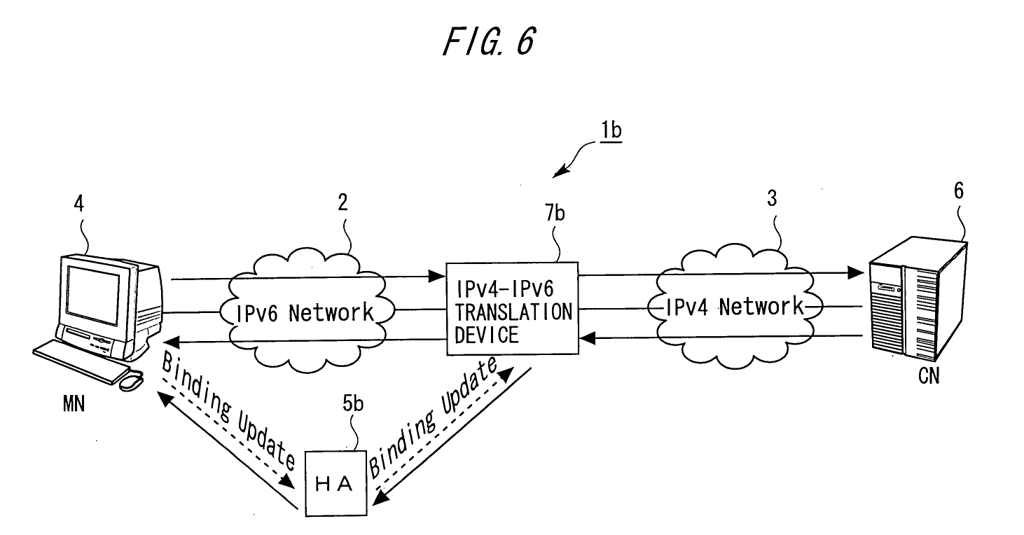

FIG. 6 is a view showing an outline of an IPv4-IPv6 translation system 1b that uses a second embodiment of the address translation device according to the present invention, i.e., uses an IPv4-IPv6 translation device 7b. Only a different point of the IPv4-IPv6 translation system 1b shown in FIG. 6 from the IPv4-IPv6 translation system 1a will hereinafter be explained.

The IPv4-IPv6 translation system 1b is different from the IPv4-IPv6 translation system 1a in terms of a point of including an IPv4-IPv6 translation device 7b, HA 5b as substitutes for the IPv4-IPv6 translation device, HA 5a, respectively.

The HA 5b is different from the HA 5a in terms of such a point that when receiving the registration message from the MN 4, it forwards the received registration message to the IPv4-IPv6 translation device 7b.

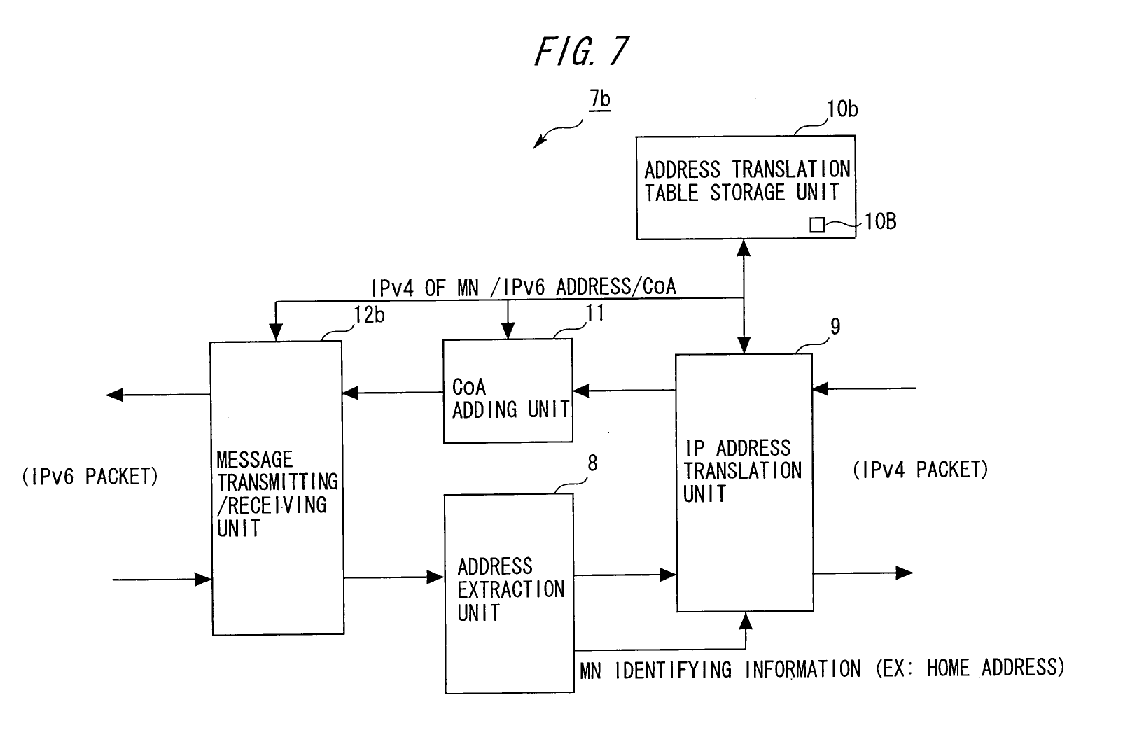

Next, the IPv4-IPv6 translation device 7b will be explained. FIG. 7 is a block diagram showing an architecture of the IPv4-IPv6 translation device 7b. The IPv4-IPv6 translation device 7b is different from the IPv4-IPv6 translation device 7a in terms of a point of further including a CoA adding (assigning) unit 11 and a message transmitting/receiving unit 12b, and a point of including an address translation table storage unit 10b as a substitute for the address translation table storage unit 10a.

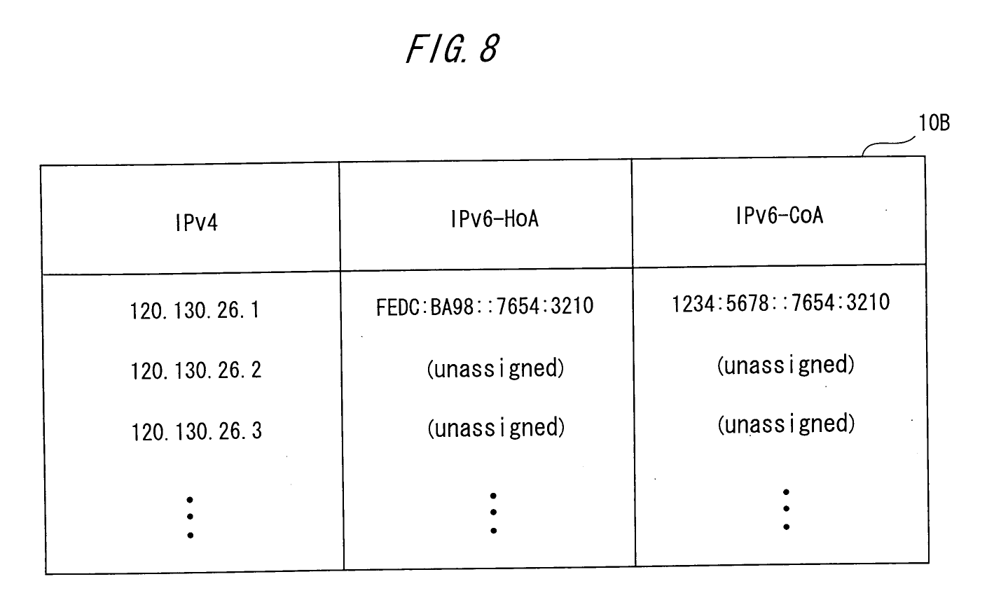

The address translation table storage unit 10b is different from the address translation table storage unit 10a in terms of a point of storing an address translation table 10B in place of the address translation table 10A. FIG. 8 is a diagram showing an example of a structure of the address translation table 10B. The address translation table 10B is different from the address translation table 10A in terms of a point that the entry to be recorded further contains a care-of address of the MN 4.

The CoA adding unit 11 is constructed of by using a CPU, a RAM, etc. The CoA adding unit 11, on the occasion that the IP address translation unit 9 executes the IPv4/IPv6 header translation, adds the care-of address to the packet becoming an object of this processing. At this time, the CoA adding unit 11 checks whether or not the care-of address mapping to the home address contained in the IPv6 header of the packet becoming the processing object of the IPv4/IPv6 header translation, is recorded in the address translation table 10B. Then, in case the care-of address is recorded, the CoA adding unit 11 reads this care-of address and adds it to this packet. On the other hand, the CoA adding unit 11, in case the care-of address mapping thereto is not recorded in the address translation table 10B, does not manipulate this packet and transfers it to the message transmitting/receiving unit 12b. Namely, in this case, the care-of address is not added to this packet.

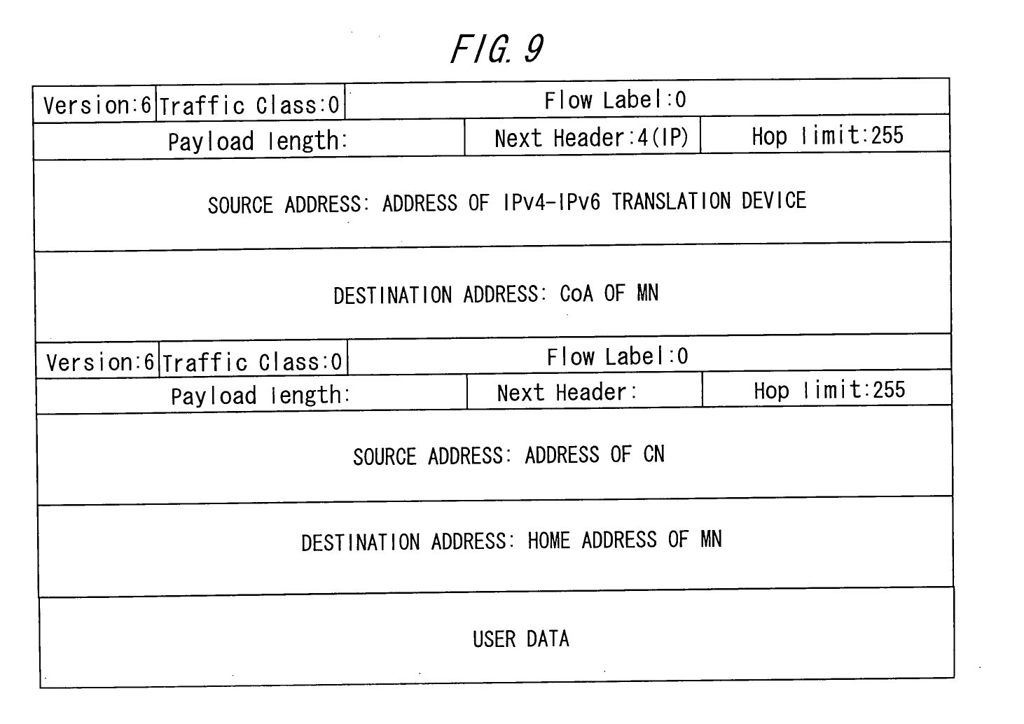

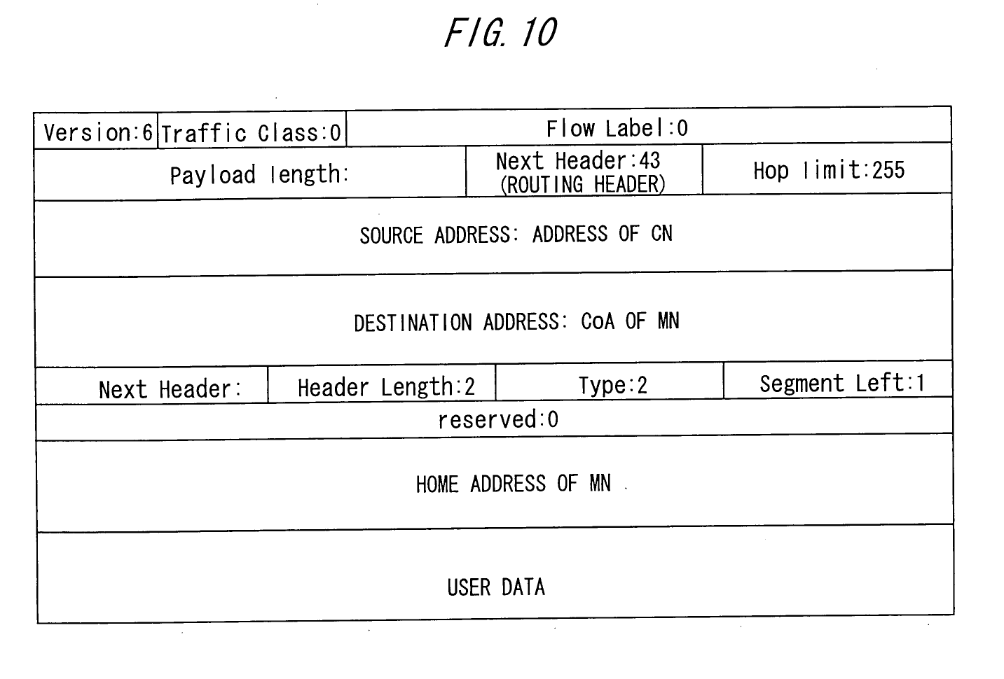

The CoA adding unit 11, on the occasion of adding the readout care-of address to the packet, adds it by using any one of an encapsulation method and a routing header method. FIGS. 9, 10 are diagrams showing data structures in the case of adopting the encapsulation method and the routing header method, respectively.

In the encapsulation method, the CoA adding unit 11 adds the care-of address to the packet by encapsulating the packet using the readout care-of address (see FIG. 9). On the other hand, in the routing header method, the CoA adding unit 11 rewrites the destination address (the home address of the MN 4) in the IPv6 header into the readout care-of address, thereby adding the care-of address to the packet.

The message transmitting/receiving unit 12b is constructed by use of a CPU, a RAM and so on. The message transmitting/receiving unit 12b judges whether the packet received from the IPv6 network is a registration message or a packet that should be forwarded to the IPv4 network 3.

In case the received packet is the registration message, the message transmitting/receiving unit 12b records a content of this registration message in the address translation table 10B. To be concrete, the message transmitting/receiving unit 12b records, in the address translation table 10B, the home address and the care-of address which are contained in the received registration message in a way that makes them mapping to each other. At this time, the message transmitting/receiving unit 12b, in a case where an entry containing the home address contained in the registration message has already been recorded in the address translation table 10B by the IP address translation unit 9, records the care-of address contained in the registration message in this entry.

On the other hand, in case the received packet is a packet that should be forwarded to the IPv4 network 3, the message transmitting/receiving unit 12b transfers this packet to the address extraction unit 8.

<Operation Sequence>

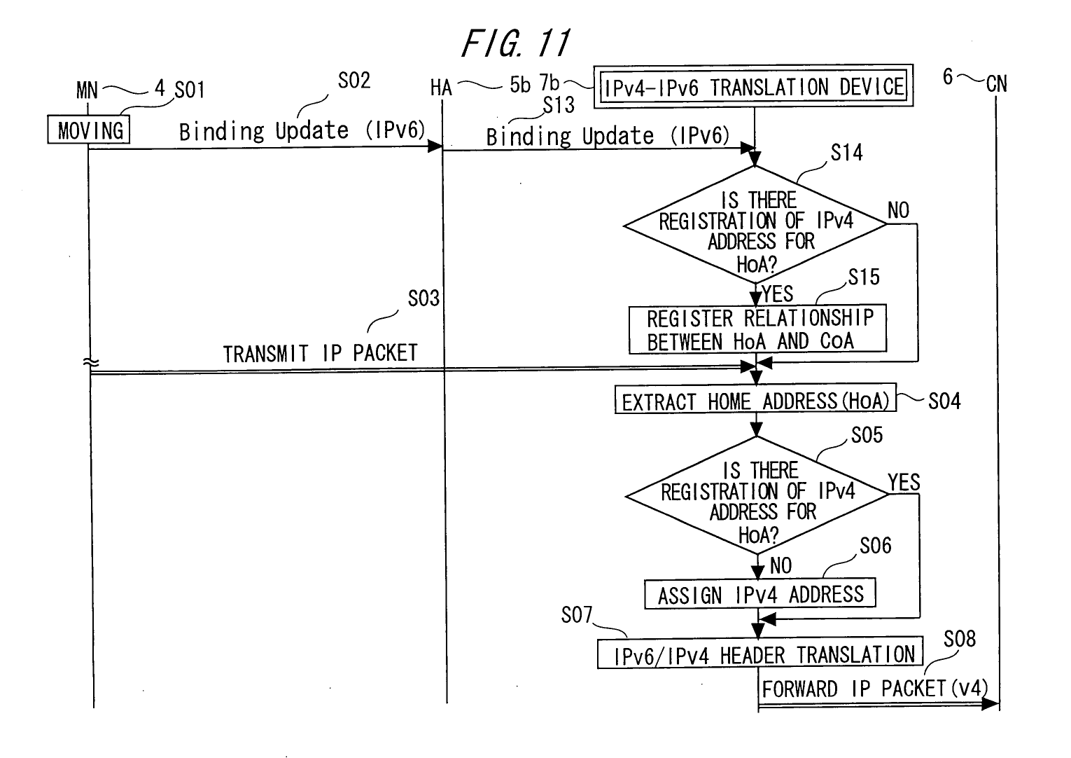

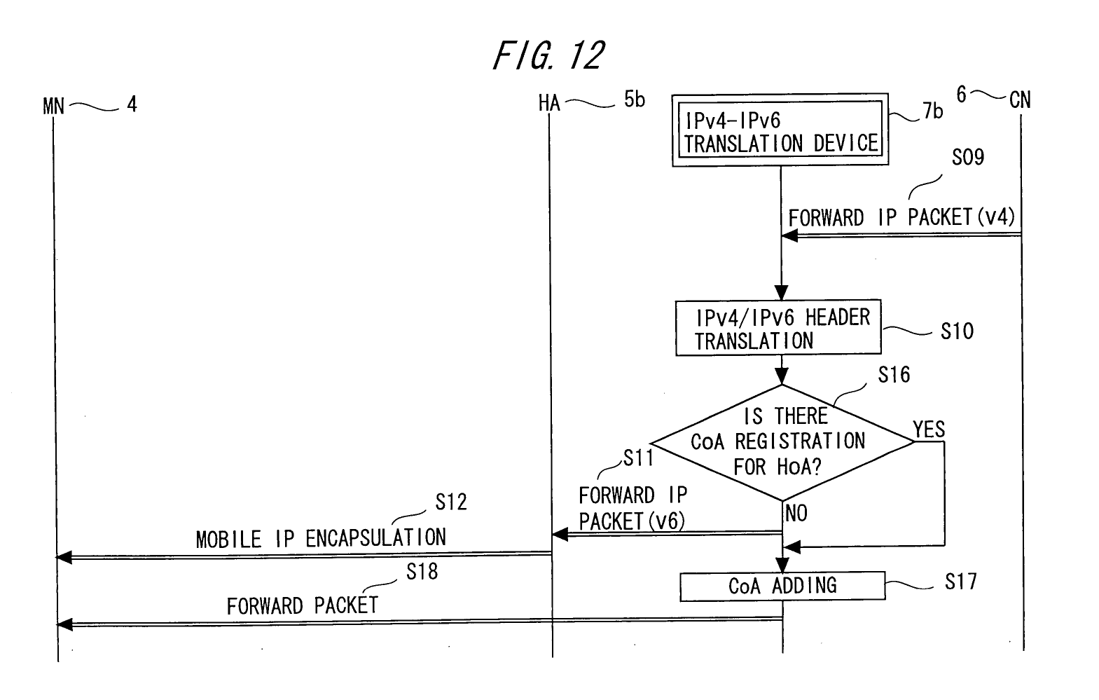

FIGS. 11, 12 are diagrams showing an operation sequence of the IPv4-IPv6 translation system 1b using the second embodiment of the invention. The operation sequence of the IPv4-IPv6 translation system 1b will hereinafter be described by use of FIGS. 11, 12 by dividing it into a location registering process and an IPv4/IPv6 forwarding process. With respect to each of the processes, only a different point from the IPv4-IPv6 translation system 1a using the first embodiment will be explained. Therefore, the explanation of the IPv4/IPv6 forwarding process that is the same operation sequence as that of the IPv4-IPv6 translation system 1a using the first embodiment, is omitted.

<<Location Registering Process>>

At first, the location registering process will be explained by use of FIG. 11. The HA 5b, upon receiving the registration message from the MN 4, forwards the received registration message to the IPv4-IPv6 translation device 7b (S13).

When the IPv4-IPv6 translation device 7b receives the registration message, the message transmitting/receiving unit 12b checks, with respect to the address translation table 10B, whether or not there is an entry containing the home address contained in the received registration message (S14). Namely, the message transmitting/receiving unit 12b checks whether there is an entry containing the home address contained in the received registration message. In case this entry exists (S14-Yes), the care-of address contained in the received registration message is recorded in this entry. Namely, the message transmitting/receiving unit 12b registers a relationship between the home address and the care-of address contained in the received registration message in the address translation table 10B (S15). While on the other hand, in case there is not the entry (S14-No), or after the process in S15, the location registration process comes to an end.

<<IPv4/IPv6 Forwarding Process>>

Next, the IPv4/IPv6 forwarding process will be explained by using FIG. 12. After the IP address translation unit 9 has executed the IPv4/IPv6 header translation (S10), the CoA adding unit 11 checks, with respect to the address translation table 10B, whether or not there is the care-of address mapping to the home address contained in the packet as the processing object (S16). In case there is not the care-of address (S16-No), the same processes as S11, S12 in the operation sequence of the IPv4-IPv6 translation system 1a, are executed. While on the other hand, in case there is the care-of address (S16-Yes), the CoA adding unit 11 adds this care-of address to the packet as the processing object (S17), and forwards this packet to the MN 4 (S18). Thus, in the IPv4/IPv6 forwarding process in the second embodiment, there is the case in which the packet is forwarded to the MN 4 by bypassing the HA 5b.

<Operation*Effect>

According to the second embodiment of the invention, the address translation table storage unit 10b is stored with the home address and the care-of address of the MN 4 in a way that makes them mapping to each other. Then, the CoA adding unit 11 adds, as it replaces the HA 5b, the care-of address to the packet transmitted to the MN 4 from the CN 6.

Therefore, the packet to which the care-of address has been added by the CoA adding unit 11, is forwarded directly to the MN 4 by bypassing the HA 5b. Accordingly, a scheme of optimizing the route for this packet is done. Hence, it is possible to scheme to reduce an intra-network forwarding time of the packet and decrease intra-network resources.

<Modified Example>

The message transmitting/receiving unit 12b may be, regardless of whether or not the entry containing the home address contained in the registration message has already been recorded, constructed to record afresh an entry containing the IPv4 address, the home address and the care-of address in cooperation with the IP address translation unit 9.

[Third Embodiment]

<System Architecture>

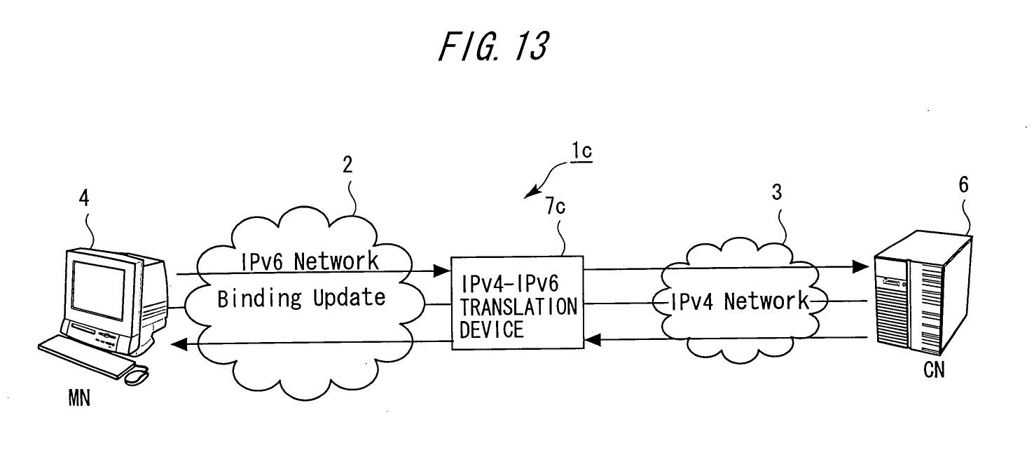

FIG. 13 is a view showing an outline of an IPv4-IPv6 translation system 1c that uses a third embodiment of the address translation device according to the present invention, i.e., uses an IPv4-IPv6 translation device 7c. Only a different point of the IPv4-IPv6 translation system 1c shown in FIG. 13 from the IPv4-IPv6 translation system 1b will hereinafter be explained.

The IPv4-IPv6 translation system 1c is different from the IPv4-IPv6 translation system 1b in terms of a point that the HA 5b is not included.

The MN 4 has the same architecture as the same category of the device in the IPv4-IPv6 translation system 1b has, however, an IPv4-IPv6 translation device 7c is set as a home agent. Therefore, the MN 4 transmits the registration message to the IPv4-IPv6 translation device 7c.

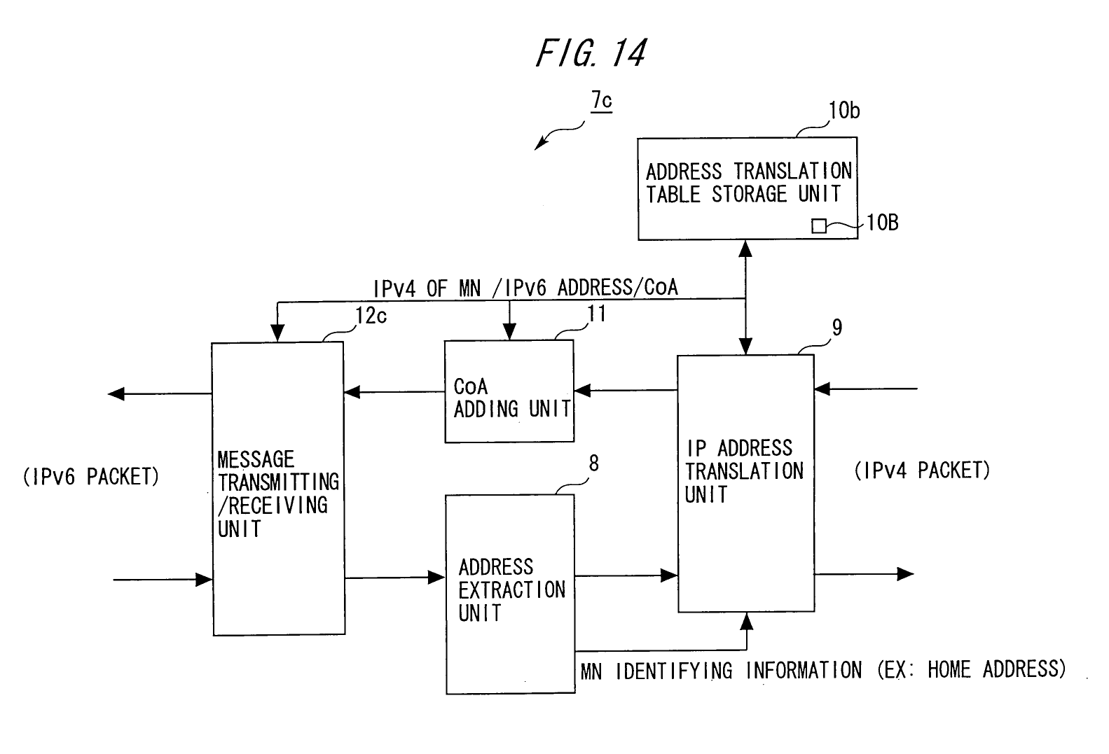

Next, the IPv4-IPv6 translation device 7c will be described. FIG. 14 is a block diagram showing an architecture of the IPv4-IPv6 translation device 7c. The IPv4-IPv6 translation device 7c is different from the IPv4-IPv6 translation device 7b in terms of a point of including a message transmitting/receiving unit 12c replacing the message transmitting/receiving unit 12b.

The message transmitting/receiving unit 12c is different from the message transmitting/receiving unit 12b in terms of a point of recording, upon receiving the registration message, the entry with the care-of address contained in this registration message irrespective of whether or not there is the entry containing the home address contained in the received registration message. Concretely, message transmitting/receiving unit 12c, in case there has already been the entry containing the home address, records this entry with the home address contained in the received registration message. On the other hand, message transmitting/receiving unit 12c, in case there is not the entry containing the home address, registers afresh an entry excluding the IPv4 address but containing the home address and the care-of address that are contained in the registration message received.

<Operation Sequence>

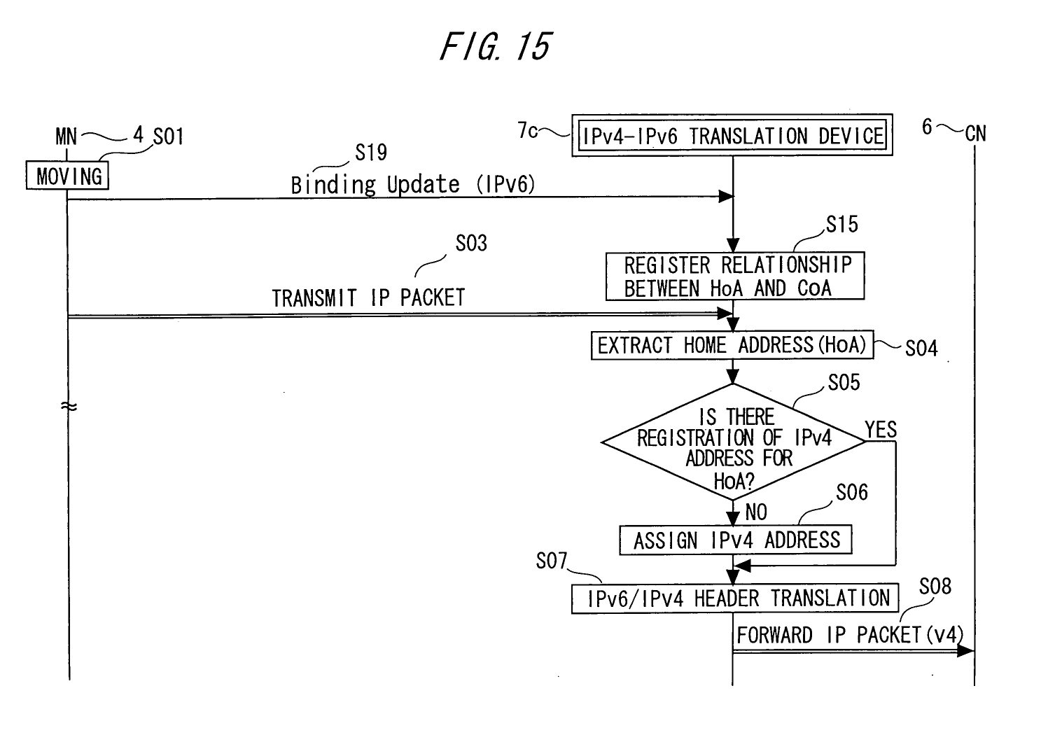

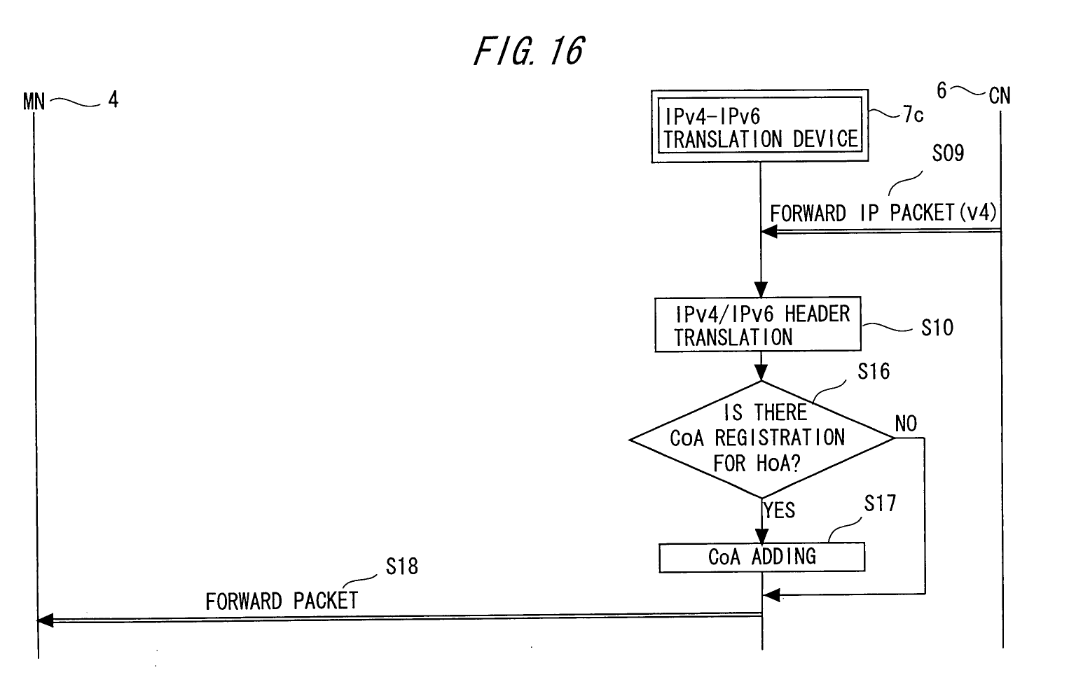

FIGS. 15, 16 are diagrams showing an operation sequence of the IPv4-IPv6 translation system 1c using the third embodiment of the invention. The operation sequence of the IPv4-IPv6 translation system 1c will hereinafter be described by use of FIGS. 15, 16 by dividing it into a location registering process and an IPv4/IPv6 forwarding process. With respect to each of the processes, only a different point from the IPv4-IPv6 translation system 1b using the second embodiment will be explained. Therefore, the explanation of the IPv4/IPv6 forwarding process that is the same operation sequence as that of the IPv4-IPv6 translation system 1b using the second embodiment, is omitted.

<<Location Registering Process>>

At first, the location registering process will be explained by use of FIG. 15. In the location registering process by the IPv4-IPv6 translation system 1c, the MN 4, according to setting made for itself (concretely, the IPv4-IPv6 translation device 7c is set as a home agent), transmits the registration message to the IPv4-IPv6 translation device 7c (S19). The IPv4-IPv6 translation device 7c, upon receiving the registration message, stores the home address and the care-of address in a way that makes them mapping to each other (S15).

<<IPv4/IPv6 Forwarding Process>>

Next, the IPv4/IPv6 forwarding process will be explained by using FIG. 16. In the IPv4/IPv6 forwarding process by the IPv4-IPv6 translation device 7c, after the IP address translation unit 9 has executed the IPv4/IPv6 header translation (S10), the CoA adding unit 11 checks, with respect to the address translation table 10B, whether or not there is the care-of address mapping to the home address contained in the packet as the processing object (S16). In case there is the care-of address (S16-Yes), the CoA adding unit 11 adds this care-of address to the packet as the processing object (S17). Thereafter, or in case there is not the care-of address (S16-No), the IPv4-IPv6 translation device 7c forwards this packet (S18). Thus, in the IPv4/IPv6 forwarding process in the third embodiment, the packet is forwarded directly to the MN 4.

<Operation*Effect>

According to the third embodiment of the invention, the IPv4-IPv6 translation device 7c receives the registration message not from the HA 5 (HA 5a, HA 5b) but directly from the MN 4. Then, the IPv4-IPv6 translation device 7c, as it replaces the HA 5, stores a mapping relationship between the home address and the care-of address of the MN 4 as an entry. Then, the IPv4-IPv6 translation device 7c forwards the packet addressed to the MN 4 directly to the MN 4 without via the HA 5. Namely, according to the third embodiment of the invention, the IPv4-IPv6 translation device 7c has a function of the mobile IPv6 home agent.

Therefore, the communication process between the IPv4-IPv6 translation device 7c and the HA 5 can be reduced. Further, there is eliminated a necessity of recording the mapping relationship between the home address and the care-of address of the MN 4 dually both in the IPv4-IPv6 translation device 7c and in the HA 5. Accordingly, it is feasible to decrease a quantity of and a cost for equipment, etc.

<Modified Example>

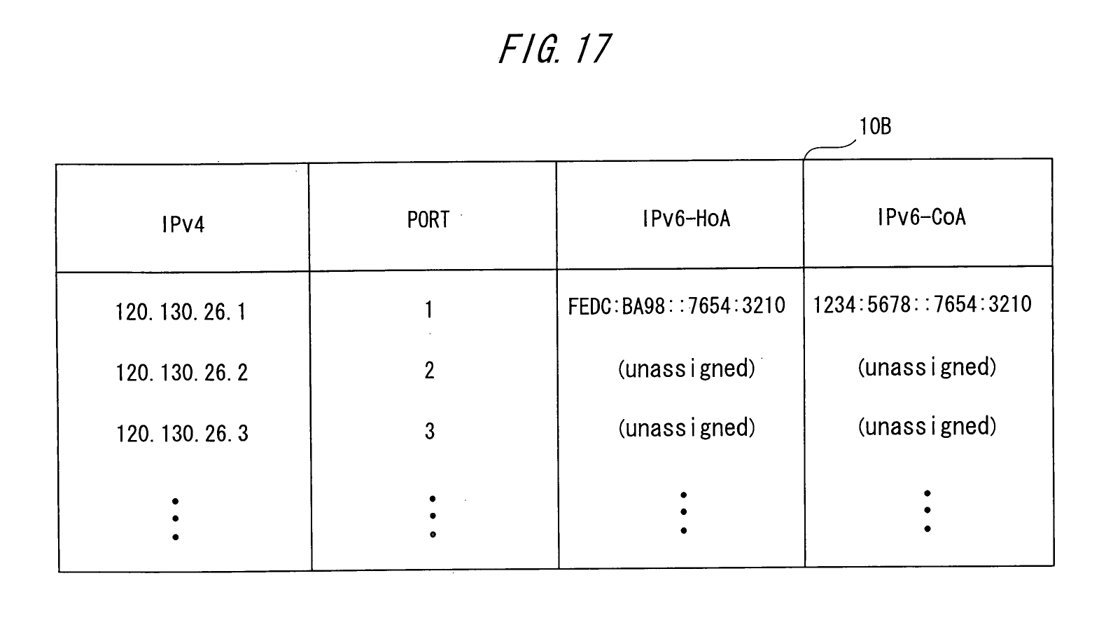

The entry in the address translation table 10B may be structured to further have a port number. FIG. 17 is a diagram showing an address translation table 10D containing the entry structured to have the port number. The address translation table 10D will be explained by use of FIG. 17.

The address translation table 10D is structured of entries in which the IPv4 address (the address temporarily assigned to the MN 4), the port number, the home address of the MN 4 and the care-of address of the MN 4 which are made mapping to each other. Namely, the mapping relationship between the home address of the MN 4 and the care-of address of the MN4 is specified by the IPv4 address and by the port number. This port number is an arbitrary number temporarily assigned together with the IPv4 address.

Therefore, even in a case where the number of the IPv4 addresses retained in the IPv4 address pool is small, the same IPv4 address can be distinguished by the plurality of port numbers. Accordingly, the mapping relationships between the plural home addresses of the MNs 4 and the care-of addresses of the MNs 4 can be made mapping to one single IPv4 address.

Thus, the port number is used as an element of the entry, which can be similarly done in the first embodiment and the second embodiment as well without being limited to the third embodiment of the invention.

According to the invention, even in case the address assigned to one terminal device is changed, the communications between on terminal device and the other terminal device can be performed seamlessly.

What is claimed is:

1. An address translation device comprising:
an extraction unit extracting, from data received via a first network, a fixed identifier indicating a transmission source of the data;
a storage unit storing the fixed identifier and an address, in a second network, of the transmission source indicated by the fixed identifier by relating fixed identifier and the address each other;
a reading unit reading the address, in the second network, stored on the storage unit and related to the fixed identifier extracted by the extraction unit; and
a replacing unit replacing the address in the second network read by the reading unit with the source address of the data.

2. An address translation device according to claim 1, further comprising:
an identifier extraction unit extracting a variable address of a terminal device connected to the first network and the fixed identifier, from the data received via the first network;
an identifier storage unit storing the variable address and the fixed identifier extracted by the identifier extraction unit by relating the variable address and the fixed identifier;
a variable address acquisition unit acquiring, from the storage unit and the identifier storage unit, the variable address corresponding to a destination address of the data addressed to the terminal device, which contains, as a destination address, the address in the second network received via the second network; and
a rewriting unit rewriting the destination address of the received data into the variable address acquired by the variable address acquisition unit.

3. A packet translation device, interposed between an IPv6 (Internet Protocol version 6) network and an IPv4 (Internet Protocol version 4) network, for mutually translating an IPv4 packet and an IPv6 packet, comprising:
an extraction unit extracting, from the IPv6 packet, a fixed identifier indicating a transmission source of the IPv6 packet;
a storage unit storing the fixed identifier and an IPv4 address assigned to the transmission source by relating the fixed identifier and an IPv4 address each other;
a reading unit reading the IPv4 address stored on the storage unit and related to the fixed identifier extracted by the extraction unit; and
a packet translating unit translating the IPv6 packet into the IPv4 packet with the IPv4 address read by the reading unit being set as a source address.

4. A packet translation device according to claim 3, further comprising:
an identifier receiving unit receiving data containing a care-of address of an IPv6 terminal device and the fixed identifier indicating the IPv6 terminal device;
an identifier storage unit storing the care-of address and the fixed identifier that have been received by the identifier receiving unit by relating to the care-of address and the fixed identifier each other; and
a care-of address acquisition unit acquiring the care-of address corresponding to a destination address of the received IPv4 packet from the storage unit and from the identifier storage unit,
wherein the packet translating unit translates the IPv4 packet into an IPv6 packet with the care-of address acquired by the care-of address acquisition unit being set as a destination address.

5. A packet translation device according to claim 3 or 4, wherein the fixed identifier is a home address of the IPv6 terminal device.

6. A packet translation device according to claim 3 or 4, wherein the storage unit further stores a port number by relating the port number, the address and the fixed identifier each other, and
wherein the reading unit reads the IPv4 address and the source port number stored on the storage unit and related to the fixed identifier extracted by the extraction unit.

7. A packet translation device according to claim 6, wherein the care-of address acquisition unit acquires, from the storage unit and the identifier storage unit, a care-of address corresponding to the destination address and the destination port number of the IPv4 packet received.

8. A packet translation system comprising:
a packet translation device, interposed between an IPv6 (Internet Protocol version 6) network and an IPv4 (Internet Protocol version 4) network, for mutually translating an IPv4 packet and an IPv6 packet, comprising:
an extraction unit extracting, from the IPv6 packet, a fixed identifier indicating a transmission source of the IPv6 packet;
a storage unit storing the fixed identifier and an IPv4 address assigned to the transmission source by relating the fixed identifier and an IPv4 address each other;
a reading unit reading the IPv4 address stored on the storage unit and related to the fixed identifier extracted by the extraction unit;
a packet translating unit translating the IPv6 packet into the IPv4 packet with the IPv4 address read by the reading unit being set as a source address;
an identifier receiving unit receiving data containing a care-of address of an IPv6 terminal device and the fixed identifier indicating the IPv6 terminal device;
an identifier storage unit storing the care-of address and the fixed identifier that have been received by the identifier receiving unit by relating the care-of address and the fixed identifier each other; and
a care-of address acquisition unit acquiring the care-of address corresponding to a destination address of the received IPv4 packet from the storage unit and the identifier storage unit,
wherein the packet translating unit translates the IPv4 packet into an IPv6 packet with the care-of address acquired by the care-of address acquisition unit being set as a destination address;
an IPv6 terminal device transmitting, to a home agent set in the device itself, a registration message containing a care-of address and a home address that are assigned to the device itself; and
a home agent forwarding, upon receiving the registration message from the IPv6 terminal device, the received registration message to the packet translation device.

9. A packet translation system comprising:
a packet translation device, interposed between an IPv6 (Internet Protocol version 6) network and an IPv4 (Internet Protocol version 4) network, for mutually translating an IPv4 packet and an IPv6 packet, comprising:
an extraction unit extracting, from the IPv6 packet, a fixed identifier indicating a transmission source of the IPv6 packet;
a storage unit storing the fixed identifier and an IPv4 address assigned to the transmission source by relating the fixed identifier and an IPv4 address each other;
a reading unit reading the IPv4 address stored on the storage unit related to the fixed identifier extracted by the extraction unit;
a packet translating unit translating the IPv6 packet into the IPv4 packet with the IPv4 address read by the reading unit being set as a source address;
an identifier receiving unit receiving data containing a care-of address of an IPv6 terminal device and the fixed identifier indicating the IPv6 terminal device;
an identifier storage unit storing the care-of address and the fixed identifier that have been received by the identifier receiving unit by relating the care-of address and the fixed identifier each other; and
a care-of address acquisition unit acquiring the care-of address corresponding to a destination address of the received IPv4 packet from the storage unit and the identifier storage unit,
wherein the packet translating unit translates the IPv4 packet into an IPv6 packet with the care-of address acquired by the care-of address acquisition unit being set as a destination address; and
an IPv6 terminal device for transmitting, to the packet translation device set in the device itself, a registration message containing a care-of address and a home address that are assigned to the device itself.
